(19) United States
(12) Patent Application Publication
(10) Pub. No.: US 2026/0240107 A1
(43) Pub. Date: Aug. 20, 2026

(54) BIOCHAR-INFUSED WOOD FIBER BEDDING

(71) Applicant: Musser Biomass and Wood Products, LLC, Rural Retreat, VA (US)

(72) Inventor: Ronald Edward Musser, Rural Retreat, VA (US)

(21) Appl. No.: 19/544,152

(22) Filed: Feb. 19, 2026

Related U.S. Application Data
(60) Provisional application No. 63/760,404, filed on Feb. 19, 2025.

(51) Int. Cl. A01K 1/015; B01J 20/20; B01J 20/24; B01J 20/28; B01J 20/30

(52) U.S. Cl. CPC A01K 1/0155; B01J 20/20; B01J 20/24; B01J 20/28011; B01J 20/28026; B01J 20/3021; B01J 20/3028; B01J 20/3078

(57) ABSTRACT

A method for producing biochar-infused wood fiber material for bedding includes separately preparing biochar and wood fiber, then integrating biochar into wood fiber. This method preserves porosity and adsorption properties of biochar, while retaining structural rigidity of wood fiber to provide desirable moisture absorption, ammonia control, and microbial reduction capabilities.

### CROSS-REFERENCE

The patent application claims priority, to and the benefit of, U.S. Provisional Patent Application No. 63/760,404, entitled “BIOCHAR-INFUSED WOOD FIBER PELLETS,” filed Feb. 19, 2025, and hereby incorporated by reference in its entirety for all purposes.

### BACKGROUND

### Field of te Invention

The present invention relates to systems and methods for producing biochar-integrated wood fiber material for use, for example, in animal bedding, agricultural applications, and environmental management. The techniques presented herein integrate biochar into wood fiber while maintaining the distinct properties of each input to enhance moisture absorption, ammonia control, and pathogen reduction.

### Related Art

Animal bedding materials must effectively manage moisture, odors, and pathogens to ensure a healthy environment. Traditional bedding (e.g., wood material) solutions struggle with ammonia buildup and microbial growth, leading to respiratory stress in poultry and livestock. While biochar has proven effective in improving air quality and reducing contaminants, its loose form presents challenges, such as dust generation and inconsistent distribution.

### BRIEF DESCRIPTION OF DRAWINGS

FIG. 1 is a schematic diagram of a system for producing biochar-integrated wood fiber bedding, in accordance with embodiments disclosed herein;

FIG. 2 is a flow process for producing biochar-integrated wood fiber bedding, in accordance with embodiments disclosed herein;

FIG. 3 is a side view of biochar-integrated wood fiber bedding in a loose form, in accordance with embodiments disclosed herein;

FIG. 4 is a top view of biochar-integrated wood fiber bedding in a pelletized form, in accordance with embodiments disclosed herein; and

FIG. 5 is a flowchart of a method for producing biochar-integrated wood fiber bedding, in accordance with embodiments disclosed herein.

### DETAILED DESCRIPTION

Presented herein are techniques for producing biochar-integrated wood fiber bedding, which can be used in poultry, livestock, equine, and/or small-animal housing for agricultural purposes. Specifically, wood fiber and biochar are separately prepared and integrated with one another through a controlled integration process to preserve distinct functional properties of both wood fiber and biochar. The biochar-integrated wood fiber bedding presented herein enables greater ammonia reduction and moisture management relative to bedding composed of wood material alone, while also reducing dust and improving ease of distribution (e.g., to provide consistent bedding depth) as compared to bedding composed of biochar material alone.

Specifically, embodiments disclosed herein “integrate” biochar with wood fiber through an infusion (integration) process that is distinct from merely “mixing” biochar and wood fiber. In particular, as used herein, “integration” refers to a process in which the biochar is infused and distributed within the matrix of the wood fiber to produce particles of biochar-integrated wood fiber. That is, using the techniques presented herein, the wood fiber and biochar are formed into a physically combined structure (e.g., a hybrid composite), referred to as “biochar-integrated wood fiber.” This is different from a mixture of biochar and wood fiber where the biochar and wood fiber remain as physically separate components.

While a bedding composed of a mixture of biochar and wood fiber may provide some benefits, such as ammonia reduction, such bedding may still suffer from shortcomings related to the dust-like or ashy consistency of biochar, which can lead to uneven distribution of biochar in bedding, increased degradation of biochar (e.g., caused by drying and/or excessive thermal exposure), and/or dust generation. However, integrating biochar into wood fiber yields a final product that provides benefits related to biochar and consistency/textural benefits related to wood fiber, including maintaining biochar distribution throughout bedding for more consistent performance.

Although biochar-integrated wood fiber material is primarily discussed as being used for bedding in this disclosure, it should be noted that biochar-integrated wood fiber material produced via techniques discussed herein can be used in other applications. By way of example, biochar-integrated wood fiber material can be used as soil amendment for sustainable waste management and/or in any other implementation in which absorption and/or adsorption is desired.

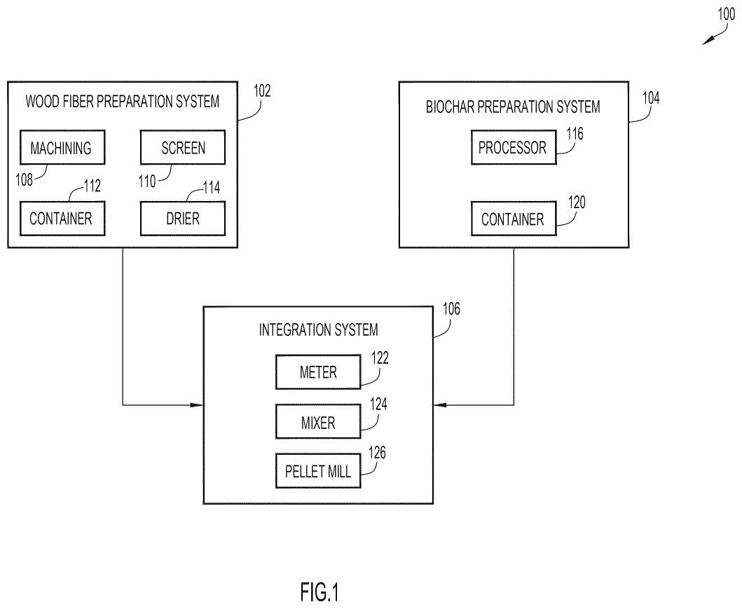

FIG. 1 is a schematic diagram of a system 100 (e.g., a bedding manufacturing system) for producing biochar-integrated wood fiber bedding. The system 100 includes a wood fiber preparation system 102 configured to prepare wood fiber particles for use in an integration process, as well as a biochar preparation system 104 configured to prepare biochar particles for use in the integration process.

The wood fiber preparation system 102 includes machining equipment 108 for processing raw wood material into smaller, individual particles, such as chips. The machining equipment 108 can include a grinder, a mill, a chipper, a hammer mill, a disc refiner, a knife ring flaker, a shredder, or combinations thereof. In some embodiments, the machining equipment 108 includes a primary size reduction device (e.g., a chipper or shredder) followed by a secondary refinement device (e.g., a grinder or hammer mill) to achieve a desired particle size distribution.

The wood fiber preparation system 102 further includes a screen 110 for removing oversized particles and excessively fine particles, thereby yielding particles having substantially uniform sizes. The screen 110 could have a number of different arrangements to pass through substantially uniform-sized particles. For example, the screen 110 can be configured as a multi-deck vibrating screen with different mesh sizes for staged separation, a rotary drum screen for continuous particle classification, or an air classification system using airflow to separate particles by density and size, etc. Some embodiments include a cyclone separator for removing fines without mechanical screening. In some examples, oversized particles removed by the screen 110 can be recirculated back to the machining equipment 108 for further processing, or can be collected separately for alternative uses.

Particles passing through the screen 110 can be stored in a first container 112 of the wood fiber preparation system 102. In some embodiments, multiple containers can be provided to store different particle size fractions separately. The first container 112 can feed particles to a drier 114, which performs a dehydration process to reduce moisture content in the wood fiber particles. Alternatively, particles can be conveyed pneumatically directly to the drier 114 without intermediate storage in the first container 112.

The drier 114 can be configured as a rotary drum dryer with heated air circulation, a flash dryer for rapid moisture removal, a fluidized bed dryer for uniform heat distribution, a microwave or radio frequency dryer for volumetric heating, a solar dryer for energy-efficient moisture reduction, or a superheated steam dryer to prevent oxidation, etc. In some embodiments, raw wood material can be pre-dried before being processed by the machining equipment 108 to reduce energy consumption during size reduction. In other embodiments, the wood fiber preparation system 102 can employ wet processing followed by mechanical dewatering (e.g., pressing) before thermal drying in the drier 114. Some embodiments combine grinding and drying in a single unit operation to reduce handling steps and improve process efficiency.

Separately, the biochar preparation system 104 can include creating biochar from biomass and/or processing biochar into finer particles, such as having an ashy consistency. Biochar can be produced using various methods, including pyrolysis reactors (slow, fast, or flash pyrolysis), gasification systems with char collection, hydrothermal carbonization (HTC) for wet biomass processing, torrefaction units for mild thermal treatment, retort kilns for batch production, or continuous rotary kilns for large-scale production. In some embodiments, biochar is produced on-site from biomass feedstock, while in other embodiments, pre-made biochar is purchased and processed.

To this end, the biochar preparation system 104 includes processing equipment 116 for reducing biochar particle size and classifying particles. The processing equipment 116 can include, for example, grinding equipment such as ball mills for ultra-fine grinding to ashy consistency, jet mills for micronization without heat generation, pin mills for high-speed impact grinding, roller mills for controlled particle size reduction, attrition mills for friable biochar materials, or cryogenic grinding systems to make brittle biochar easier to pulverize. The processing equipment 116 can also include screening equipment such as air classifiers to separate fine biochar particles by aerodynamic properties, sieve shakers with multiple mesh sizes, spiral classifiers for continuous separation, electrostatic separators to remove contaminants, or magnetic separators if biochar contains metallic impurities.

In some embodiments, biochar can be activated (chemically or physically), washed, or treated to adjust pH or surface chemistry before particle size reduction. Some embodiments classify biochar into multiple size fractions for different applications, or coat and functionalize biochar particles after grinding. Alternative embodiments include shared processing equipment between wood fiber and biochar systems, dedicated parallel processing lines for different biochar feedstocks, or mobile processing units versus fixed installations.

The biochar preparation system 104 can also include a second container 120, separate from the first container 112, for storing biochar particles. In alternative embodiments, the second container 120 can be configured as a sealed silo with inert atmosphere to prevent oxidation, bulk bags for flexible storage capacity, hoppers with live-bottom discharge for consistent feed rates, multiple containers segregating different biochar particle sizes or feedstock sources, or integrated storage-mixing vessels that combine storage with agitation.

The system 100 further includes an integration system 106. The integration system 106 is configured to receive wood fiber particles from the wood fiber preparation system 102 (e.g., the drier 114) and biochar particles from the biochar preparation system 104 (e.g., the second container 120). The integration system 106 is then configured to integrate the biochar particles into the wood fiber particles to produce biochar-integrated wood fiber particles (e.g., a physically combined structure, a hybrid composite). For example, the integration system 106 includes one or more meters 122 to controllably meter biochar and/or wood fiber volumetrically. The meter(s) 122 can include a belt feeder, auger feeder, rotary valve, or the like, to controllably flow biochar and/or wood fiber by volume instead of by weight to integrate biochar into wood fiber at a target volumetric ratio.

In some embodiments, separate meters 122 can be used to control individual flows of biochar and wood fiber to achieve the target volumetric ratio. The integration system 106 also includes a mixer 124 to effectuate integration of biochar into wood fiber. The mixer 124 (e.g., blending auger, ribbon blender, paddle mixer) can blend the mixture of biochar particles and wood fiber particles. Such a mixer 124 is controlled to avoid pulverizing biochar while ensuring uniform dispersion of biochar with wood fiber. Additionally or alternatively, a surface application technique is performed in which biochar is applied onto wood fiber particles via controlled volumetric dosing via the meter(s) 122 during transfer (e.g., on a conveyor, in a mixing drum), and a liquid can be applied, such as via light misting, to provide moisture conditioning that reduces dust and improves adhesion of biochar to wood fiber. In further embodiments, a layered integration technique can be used by the mixer 124 in which biochar-rich fiber and non-biochar fiber are interleaved with one another (e.g., biochar-rich fiber is applied as a base layer and non-biochar fiber is applied as a top layer, or vice versa). Such an approach can allow for greater flexibility in the composition of the final product (e.g., for different bedding strategies) while maintaining desirable properties, such as ammonia adsorption and/or moisture control.

In some embodiments, the integration system 106 can also treat the biochar-integrated wood fiber particles to have properties suitable for usage as bedding. For example, the integration system 106 can further include a pellet mill 126 configured to pelletize the biochar-integrated wood fiber. Specifically, biochar-integrated wood fiber material is fed to the pellet mill 126 under controlled pressure and die conditions to avoid excessive heat or mechanical destruction of biochar pore structure, and the pellet mill 126 presses and compacts the biochar-integrated wood fiber to form pellets. Moisture conditioning can be adjusted to account for the adsorption of biochar and its potential impact of pellet binding.

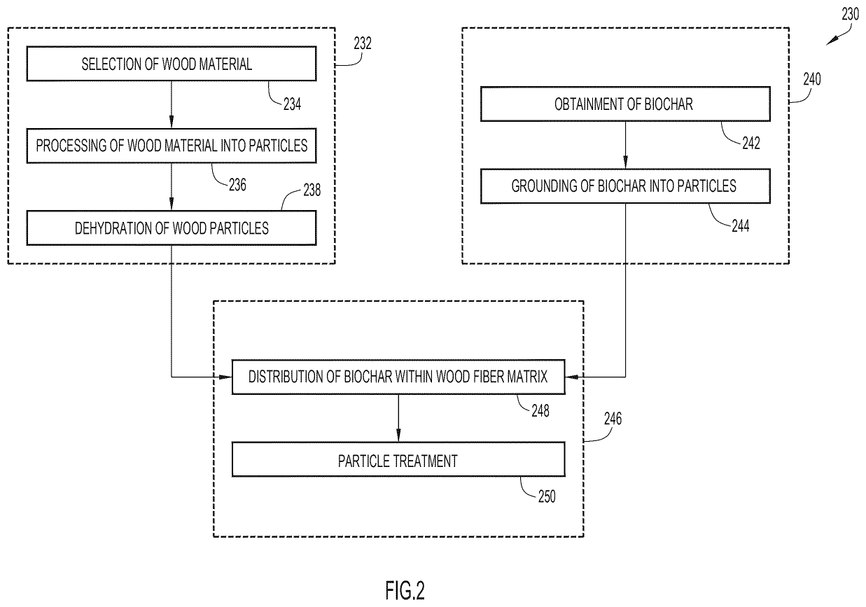

FIG. 2 illustrates a flow process 230 to form biochar-integrated wood fiber bedding, such as via operation of the system 100. The flow process 230 includes separately preparing wood fiber and biochar. For example, the flow process 230 includes a wood fiber preparation process 232 dedicated to preparing or handling wood fiber. That is, the wood fiber preparation process 232 does not prepare or handle (e.g., co-process, co-dry) biochar material. The wood fiber preparation process 232 includes selection of wood material at block 234. This includes selecting raw material, such as high-quality poplar or mixed wood, that have certain properties (e.g., structural rigidity, absorbency).

The raw wood material can be in a state, such as a slab, board, offcut, sheet, or block, that is not usable for bedding. Thus, the wood fiber preparation process 232 also includes processing of the wood material into particles that are more desirably sized, as shown at block 236. Such particles can include chips, flakes, strips, chunks, and/or pieces that are more suitable for use as bedding. For example, mechanical techniques (e.g., grinding, milling, cutting, chipping, flaking, stranding, refining) and/or chemical techniques (e.g., pulping, dissolving) can be used, along with a screening technique to remove oversized particles and excessive fines. The wood particles can be stored in a dedicated container (e.g., bins, silos, hoppers).

Dehydration of the wood particles, which can be fed from the dedicated storage, is then performed at block 238. The dehydration process can be performed at a low temperature, such as between approximately 180 degrees Fahrenheit to approximately 240 degrees Fahrenheit (e.g., around 200 degrees Fahrenheit (93 degrees Celsius)), in a controlled (e.g., slow-release) manner to preserve desirable capillarity and/or absorbency benefits. This low temperature dehydration process can help avoid exposing wood fiber to significantly higher heat or localized hot spots to maintain fiber structure and capillarity, which improves absorbance and wicking behavior, as well as reducing formation of brittle fiber and fines. This creates a more consistent moisture target for downstream blending and/or pelletization to help improve uniformity of biochar distribution within the matrix of wood fiber, and the limited thermal degradation produces a lighter-colored wood fiber. Such characteristics of wood fiber is more suitable and desirable than wood fiber subjected to higher temperature dehydration or overheating, which could create less consistent structure and corresponding reduced bedding performance. In an example, the resultant wood fiber can have a finished moisture of approximately 7-10 percent and a bulk density of approximately 38-40 pounds per cubic foot (approximately 609-641 kilograms per cubic meter), as well as a desirable/selected liquid absorbance rate. In some embodiments, at least some of the operations described with respect to blocks 234, 236, 238 are performed via the wood fiber preparation system 102.

The flow process 230 also includes a biochar preparation process 240 dedicated to preparing biochar. That is, the biochar preparation process 240 does not prepare or handle (e.g., co-process, co-dry) wood material. The biochar preparation process 240 includes obtainment of biochar at block 242. Obtainment of biochar can include sourcing and/or producing biochar from high-quality carbonized biomass such that the biochar includes specific adsorption properties (e.g., effectuated by porosity properties). For example, thermal-treatment and/or pyrolysis processes, including continuous-flow rotary pyrolysis systems with controlled temperature (e.g., approximately 950 degrees Fahrenheit or 510 degrees Celsius) and residence time (e.g., approximately 13 minutes), can be performed to produce biochar. The resulting biochar can then have selected properties, such as at least 90 percent fixed carbon content, less than 2 percent ash content, high porosity and internal surface area, moisture content of about 3 percent, and/or a bulk density of approximately 8-9 pounds per cubic foot (approximately 128-144 kilograms per cubic meter). Grounding and/or screening biochar to particles is then performed at block 244. This forms biochar particles that are suitably sized for subsequent integration with wood fiber and having selected properties (e.g., moisture absorption, ammonia adsorption) for use as bedding. The biochar particles can then be stored in another dedicated container (e.g., bins, silos, hoppers), separate from the container of wood particles. In certain embodiments, at least some of the operations described with respect to blocks 242, 244 are performed via the biochar preparation system 104.

The flow process 230 further includes an integration process 246 in which at least a portion of the biochar particles prepared via the biochar preparation process 240 are integrated into at least a portion of the wood fiber prepared via the wood fiber preparation process 232. The integration process 246 includes distribution of biochar within the matrix of wood fiber at block 248 to form a physically combined structure or hybrid composite. For instance, a precision blending technique (e.g., volumetric blending, surface application, layered integration) is used to evenly and uniformly distribute biochar within the matrix to maintain a relatively consistent fiber-to-biochar ratio. For instance, biochar is integrated using volumetric metering, rather than weight batching, via a volumetric feeder (e.g., auger feeder, rotary valve).

Wood fiber can also be metered with a separate volumetric feeder (e.g., belt feeder, auger feeder). The feed rates can be adjusted such that the combined discharge yields a target volumetric ratio. Critically, because biochar has a significantly different bulk density than wood fiber, volumetric rather than weight-based blending can produce more consistent distribution of biochar into the matrix of wood fiber, as well as more consistent performance and property aspects in the final product. In one example, the target volumetric ratio is 1-10 percent of biochar content by volume to provide desirable absorption/adsorption properties of biochar while maintaining structural properties of wood fiber (e.g., to avoid ashiness and reduced distribution control).

The integration process 246 can also include particle treatment at block 250. Particle treatment can provide the biochar-integrated wood fiber with other properties that are desirable in certain applications. As an example, particle treatment includes pelletization. As another example, particle treatment includes densification. For instance, the biochar-integrated wood fiber material is compressed under controlled pressure and temperature to form pellets or other compact shapes that prevent or at least discourage breakdown of biochar to preserve its adsorption and microbial reduction properties. Various pelletization parameters, such as an amount of conditioning moisture added, a die compression ratio, a feed rate, and/or a press temperature, can be adjusted to accommodate biochar for preserving pellet integrity and avoiding brittleness, while maintaining uniform biochar distribution. However, it should be noted that such particle treatment can be optional, and in some embodiments, the biochar-integrated wood fiber remains loose or minimally densified. At least some of the operations described with respect to blocks 248, 250 are performed via the integration system 106.

In any case, the structural benefits (e.g., texture, consistency, rigidity, strength) of wood fiber and porosity benefits of biochar are preserved via the integration process 246. By way of example, the resultant biochar-integrated wood fiber bedding has enhanced moisture absorption, rapid ammonia adsorption, sustained ammonia suppression over time, extended useful lifespan, and increased efficiency (e.g., effective absorption/adsorption performance at reduced bedding depth/volume), thereby improving air quality during application.

As set forth in FIGS. 1 and 2, wood fiber and biochar are handled/prepared separately (e.g., independently) before biochar is integrated into wood fiber. Separately preparing wood fiber and biochar as distinct components can help better control the respective properties for wood fiber and biochar prior to integration. For instance, the wood fiber is prepared, such as dehydrated for moisture reduction, in a manner to provide desirable absorption and/or structural properties (e.g., to maintain fiber capillarity, consistent pellet forming characteristics) without impact from concurrent biochar preparation/introduction, which can prevent or at least discourage degradation of pore structure and/or excessive dusting/handling losses.

Additionally or alternatively, biochar is prepared in a manner to provide desirable absorption and/or structural properties without impact from concurrent wood fiber preparation. Critically, this separate input management of wood fiber and biochar can prevent or at least discourage biochar from being damaged, overly heated, or unintentionally volatilized to ensure consistent dosage. Subsequent to separate preparation of wood fiber and biochar, the prepared wood fiber having desirable properties and the prepared biochar having desirable properties are infused with one another to provide a final biochar-integrated wood fiber product having corresponding desirable properties.

Indeed, the biochar-integrated wood fiber bedding more efficiently reduces the content of ammonia as compared to bedding composed of wood material alone. In one experimental procedure, a mixture of 2 ounces of ammonia and 2 ounces of water was applied to bedding 1 composed of pine having a depth of 3 inches, bedding 2 composed of poplar having a depth of 3 inches, and bedding 3 composed of biochar-integrated wood fiber having a depth of 2.5 inches. Bedding 1 reduced the content of ammonia in air from 500 parts per million (ppm) to 220 ppm in 20 hours, bedding 2 reduced the content of ammonia in air from 220 ppm to 75 ppm in 20 hours, and bedding 3 reduced the content of ammonia in air from 32 ppm to 14 ppm in 20 hours. Thus, the biochar-integrated wood fiber bedding (i.e., bedding 3) provides substantially greater ammonia reduction at reduced bedding depth with respect to pine and poplar alone. In another experimental procedure, a mixture of 2 ounces of ammonia and 1 cup of water was applied to bedding 1 composed of pine shavings having a depth of 4 inches, bedding 2 composed of pine pellets having a depth of 4 inches, bedding 3 composed of poplar pellets having a depth of 4 inches, and bedding 4 composed of biochar-integrated wood fiber having a depth of 1 inch. Bedding 1 reduced the content of ammonia in air from 430 ppm to 134 ppm in 24 hours, bedding 2 reduced the content of ammonia in air from 280 ppm to 27 ppm in 24 hours, bedding 3 reduced the content of ammonia in air from 170 ppm to 37 ppm in 24 hours, and bedding 4 reduced the content of ammonia in air from 112 ppm to approximately 0 ppm in approximately 2 hours. Therefore, the biochar-integrated wood fiber bedding (i.e., bedding 4) provided near-complete ammonia suppression using approximately 75 percent less bedding material and within a fraction of the period of time in which bedding composed of pine or poplar alone reduced ammonia content. These experimental procedures show an order-of-magnitude improvement in ammonia reduction, including rapid adsorption combined with long-duration suppression and material efficiency through reduced bedding depth/thickness, as compared to bedding composed of wood material alone.

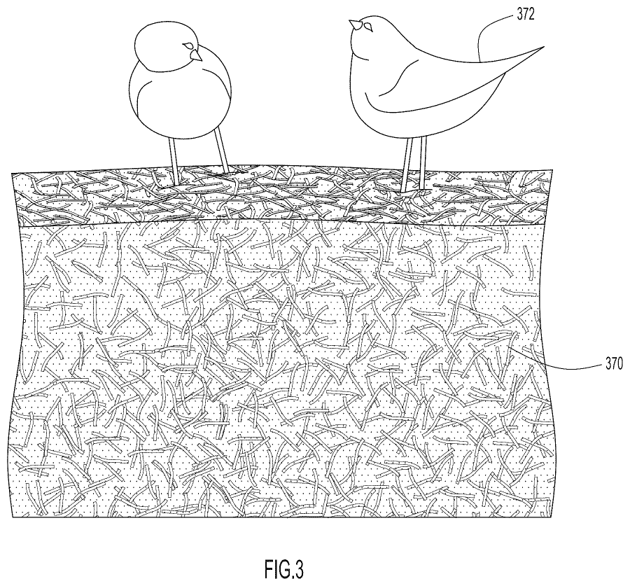

FIG. 3 is a side view of biochar-integrated wood fiber bedding 370 in an example application. Specifically, the biochar-integrated wood fiber bedding 370 is used as bedding for birds 372. As shown, when the birds 372 are positioned on the biochar-integrated wood fiber bedding 370, the biochar-integrated wood fiber bedding 370 provides sufficient support to reduce sinking of the birds 372 into the biochar-integrated wood fiber bedding 370, while preserving substantially uniform distribution and depth of the biochar-integrated wood fiber bedding 370 (e.g., within an enclosure). That is, the biochar-integrated wood fiber bedding 370 has a sufficiently stable structure that prevents or at least discourages the birds 372 from sinking and/or prevents or at least discourages uneven distribution (e.g., caused by movement of the birds 372), which can be occurring issues related to bedding having a more ashy or dusty consistency (e.g., for bedding composed of biochar alone). Therefore, in addition to having desirable absorption/adsorption properties, the biochar-integrated wood fiber bedding 370 has desirable structural properties to encourage usage as bedding.

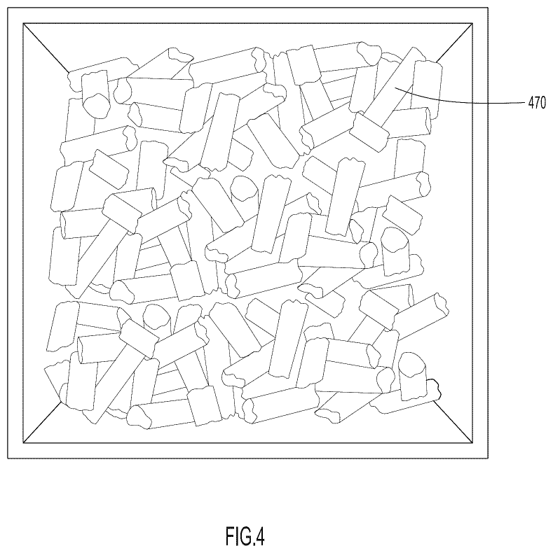

The biochar-integrated wood fiber bedding 370 of FIG. 3 is in the form of loose particles (e.g., chips, flakes, strips) that can be more easily adjusted in shape, such as via bending, compressing, etc. This can provide greater flexibility in application and bedding management practices, such as ease of allocation in a variety of different enclosures. However, biochar-integrated wood fiber bedding can also be in the form of pelletized particles that have greater structural rigidity. FIG. 4 is a top view of biochar-integrated wood fiber bedding 470 that includes pellets. The pellets are compacted to retain their shaping. This can provide greater support and/or more uniform distribution for certain applications. Thus, biochar-integrated wood fiber bedding can be pelletized or loose based on desirable applications thereof. Regardless of its final form, the biochar-integrated wood fiber bedding provides functionality of both biochar and wood fiber to achieve the benefits disclosed herein.

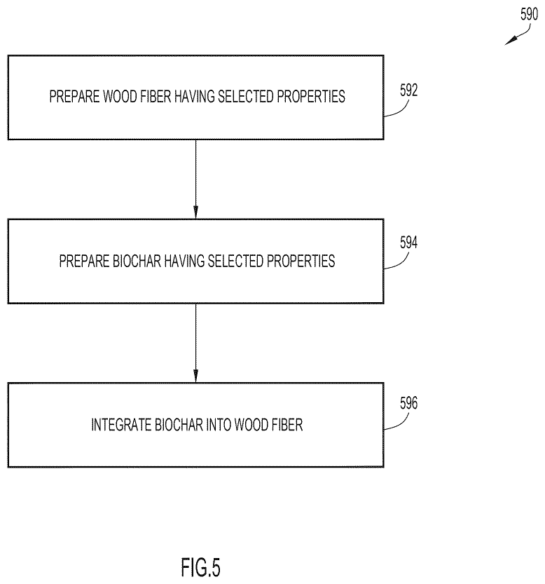

FIG. 5 is a flowchart of a method 590 for preparing biochar-integrated wood fiber bedding. It should be noted that operations of the method 590 can be performed differently than depicted. For example, an additional operation can be performed, and/or any of the depicted operations can be performed differently, performed in a different order, and/or not performed. At block 592, wood fiber having selected properties is prepared. This can include selecting wood material, processing wood material into loose particles, and/or dehydrating the loose wood particles to produce wood fiber. The resulting wood fiber has selected structural and absorption properties for usage as bedding and can be readily infused with biochar in its matrix.

At block 594, biochar having selected properties is prepared. This can include sourcing and/or producing biochar, as well as grounding/screening biochar into fine particles that can be integrated into wood fiber. The biochar also has selected absorption/adsorption properties for usage as bedding.

At block 596, at least a portion of the biochar is integrated into some of the loose particles of wood fiber. Specifically, biochar is infused and distributed within the matrix of the wood fiber to produce loose particles of biochar-integrated wood fiber. Thus, biochar and wood fiber are combined into an integrated component or hybrid composite where biochar is adhered to, embedded within, interleaved within wood fiber structure to produce bedding that provides benefits not achievable by a mere mixture of distinct biochar and wood fiber components (e.g., by adding biochar into existing wood bedding). For example, wood fiber provides structural (e.g., rigidity, resistance to excessive thermal exposure and/or dry conditions) and wicking properties to enhance bedding support and moisture flow, and biochar adsorbs ammonia traveling through the network of wood fiber structure, thereby providing. Furthermore, ensuring that each wood fiber particle is composed of a target volumetric content of biochar avoids excessive concentrations of biochar at certain regions of bedding, as well as sparse concentrations of biochar at other regions, which distributes biochar and its benefits more uniformly.

In some embodiments, loose particles of the biochar-integrated wood fiber are further pelletized/densified to produce compact pieces (e.g., pellets) that retain their shape while ensuring the properties, such as porosity and/or adsorption capability, remain intact. However, the biochar-integrated wood fiber material can remain in loose form and be in a more easily shapeable state in other embodiments.

As should be appreciated, while particular uses of the technology have been illustrated and discussed above, the disclosed technology can be used with a variety of devices in accordance with many examples of the technology. The above discussion is not meant to suggest that the disclosed technology is only suitable for implementation within systems akin to that illustrated in the figures. In general, additional configurations can be used to practice the processes and systems herein and/or some aspects described can be excluded without departing from the processes and systems disclosed herein.

In this disclosure, only some of the possible aspects were shown. Other aspects can, however, be embodied in many different forms and should not be construed as limited to the aspects set forth herein. Rather, these aspects were provided so that this disclosure was thorough and complete and fully conveyed the scope of the possible aspects to those skilled in the art.

As should be appreciated, the various aspects (e.g., portions, components, etc.) described with respect to the figures herein are not intended to limit the systems and processes to the particular aspects described. Accordingly, additional configurations can be used to practice the methods and systems herein and/or some aspects described can be excluded without departing from the methods and systems disclosed herein.

According to certain aspects, systems and non-transitory computer readable storage media are provided. The systems are configured with hardware configured to execute operations analogous to the methods of the present disclosure. The one or more non-transitory computer readable storage media comprise instructions that, when executed by one or more processors, cause the one or more processors to execute operations analogous to the methods of the present disclosure.

Similarly, where steps of a process are disclosed, those steps are described for purposes of illustrating the present methods and systems and are not intended to limit the disclosure to a particular sequence of steps. For example, the steps can be performed in differing order, two or more steps can be performed concurrently, additional steps can be performed, and disclosed steps can be excluded without departing from the present disclosure. Further, the disclosed processes can be repeated.

Although specific aspects were described herein, the scope of the technology is not limited to those specific aspects. One skilled in the art will recognize other aspects or improvements that are within the scope of the present technology. Therefore, the specific structure, acts, or media are disclosed only as illustrative aspects. The scope of the technology is defined by the following claims and any equivalents therein.

It is also to be appreciated that the embodiments presented herein are not mutually exclusive and that the various embodiments may be combined with another in any of a number of different manners.

What is claimed is:

1. A method, comprising:
preparing wood fiber;
preparing biochar; and
integrating the biochar into the wood fiber to create a biochar-integrated wood fiber material.

2. The method of claim 1, wherein integrating the biochar into the wood fiber comprises:
distributing the biochar into a matrix of the wood fiber.

3. The method of claim 1, wherein preparing the wood fiber comprises:
dehydrating wood particles.

4. The method of claim 3, wherein the biochar is integrated into the wood fiber after dehydrating wood particles.

5. The method of claim 1, wherein preparing the biochar comprises:
grinding the biochar into fine particles.

6. The method of claim 1, further comprising:
pelletizing the biochar-integrated wood fiber material.

7. The method of claim 1, further comprising:
screening the wood fiber prior to the integrating, wherein the screening produces wood fiber particles having a selected size for integration with the biochar.

8. The method of claim 1, wherein integrating the biochar into the wood fiber comprises:
infusing the biochar with the wood fiber such that biochar content of the biochar-integrated wood fiber material is approximately 1-10 percent biochar by volume.

9. The method of claim 1, wherein preparing the wood fiber produces wood fiber having a finished moisture of approximately 7-10 percent and a bulk density of approximately 38-40 pounds per cubic foot.

10. The method of claim 1, wherein preparing the biochar produces biochar having at least 90 percent fixed carbon content, less than 2 percent ash content, moisture content of 3 percent, and a bulk density of 8-9 pounds per cubic foot.

11. Agricultural bedding, comprising:
wood fiber; and
biochar infused in a matrix of the wood fiber to provide a biochar-integrated wood fiber material comprising a biochar content of less than or equal to 10 percent by volume.

12. The agricultural bedding of claim 11, wherein the wood fiber comprises poplar wood.

13. The agricultural bedding of claim 11, wherein the biochar comprises carbonized biomass.

14. The agricultural bedding of claim 11, wherein the biochar-integrated wood fiber material comprises pellets.

15. The agricultural bedding of claim 11, wherein the biochar-integrated wood fiber material comprises loose chips.

16. A system, comprising:
a biochar preparation system configured to prepare biochar material;
a wood fiber preparation system configured to prepare wood fiber material; and
an integration system configured to infuse the biochar material prepared by the biochar preparation system with the wood fiber material prepared by the wood fiber preparation system to generate a biochar-integrated wood fiber material.

17. The system of claim 16, wherein the wood fiber preparation system is configured to screen the wood fiber material to produce wood fiber particles having a selected size for integration with the biochar.

18. The system of claim 16, wherein the integration system comprises respective meters for volumetrically controlling individual flows of wood fiber material and biochar material.

19. The system of claim 16, wherein the wood fiber preparation system is configured to dehydrate the wood fiber material, and wherein the integration system is configured to integrate the biochar material with the dehydrated wood fiber material produced by the wood fiber preparation system.

20. The system of claim 16, wherein the integration system is configured to:
infuse the biochar material with the wood fiber material such that biochar content of the biochar-integrated wood fiber material is approximately 1-10 percent biochar by volume.
